(19) United States
(12) Patent Application Publication
(10) Pub. No.: US 2010/0021813 A1
(43) Pub. Date: Jan. 28, 2010

(54) ELECTRODE FOR ANY ENERGY RESERVOIR

(76) Inventors: Tim Schafer, Niedersachswerfen (DE); Andreas Gutsch, Ludinghausen (DE)

Correspondence Address: GREER, BURNS & CRAIN, 300 S WACKER DR, 25TH FLOOR, CHICAGO, IL, 60606, US

(21) Appl. No.: 12/497,077

(22) Filed: Jul. 2, 2009

(30) Foreign Application Priority Data
Mar. 7, 2008 (DE) 10 2008 031.537.0

(51) Int. Cl. H01M 6/04; C25B 11/00; C25B 9/00; H01M 4/02

(52) U.S. Cl. 429/188; 204/290.01; 204/252; 429/209

(57) ABSTRACT

An electrode for an energy storage device has an electrode bearer and an active electrode material that is applied onto the electrode bearer on one side or on both sides, the electrode bearer being formed from an alloy that has a portion of copper and that additionally contains at least tin in a content of at least approximately 0.01 weight %.

The present invention relates to an electrode for an energy storage device, and to an energy storage device having such an electrode. The present invention is described in connection with lithium-ion accumulators for driving electric vehicles or electric hybrid vehicles. It is to be noted that the present invention can also be used with batteries having a different chemistry, or independent of the use of the battery to supply the drive of an electric vehicle or an electric hybrid vehicle.

Energy storage devices are increasingly used in electric vehicles and electric hybrid vehicles, so that there is an increasing need for energy storage devices having large capacity, high power, and long-term stability. Among energy storage devices, lithium (ion) cells are particularly important as secondary cells due to their high specific energy storage density.

An example of a coated lithium-ion cell is disclosed in DE 10 2005 042 916 A1, and an example of a wound lithium-ion cell is disclosed in EP 0 949 699 B1. The energy storage device, realized here as a lithium-ion cell, contains in each case a first electrode, a second electrode, and a separating element between the first and second electrode, or an arrangement of these components in which they are alternately stacked one over the other. As is stated more precisely for example in DE 10 2005 042 916 A1, the electrodes here are standardly formed from an electrode bearer onto which an active electrode material has been applied on one side or on both sides. In the case of a lithium-ion cell, the anode is often formed from an anode bearer made of copper and an active anode material made for example of graphite, and the cathode is often formed from a cathode bearer made of aluminum and an active cathode material made of lithiated oxides.

The present invention is based on the object of providing an energy storage device having improved long-term stability, or to provide an electrode for such an energy storage device.

According to a first aspect of the invention, this object is achieved by an electrode for an energy storage device having the features of Claim 1. Advantageous constructions and developments of the present invention are the subject matter of dependent Claims 2 through 7. An energy storage device having an electrode according to the present invention is described in Claims 8 through 15.

The electrode for an energy storage device contains an electrode bearer and an active electrode material that is applied on one side or both sides of the electrode bearer. According to the present invention, it is provided that the electrode bearer is made of an alloy having a portion of copper, said alloy additionally containing at least tin with a content of at least approximately 0.01 weight %.

The above-named electrode is used to store energy. Said electrode stores the energy in chemical form. In order to emit electrical energy, this electrical energy is produced by conversion from chemically stored energy. Depending on the design of the electrode, this energy may be suitable only for a one-time discharge, or also for the absorbing of energy. During energy absorption, for example a charging process, this energy is supplied in electrical form and is converted into chemical energy. The electrode stands in at least electrical effective connection with an electrolyte and with a supply line.

The above-named energy storage device is used to supply a drive of an electric vehicle or of an electric hybrid vehicle. However, this energy storage device can also supply other drives or consumers. If the energy storage device is used only for the one-time emission of electrical energy, this is called a primary cell, or also a battery. Depending on its design, this energy storage device may also absorb electrical energy, for example through charging. In this case, one speaks of a secondary cell or an accumulator. Inside the energy storage device, or inside its at least one galvanic cell, electrical energy is converted into chemical energy and vice versa. Two electrodes and an electrolyte are involved in this energy conversion. A separate supply line is connected in electrically conductive fashion to each of these electrodes. These supply lines are in turn electrically conductively connected to a consumer, for example to the drive of a motor vehicle.

The above-named electrode has an electrode bearer. This electrode bearer is an electrically conductive solid material. This electrode bearer preferably has at least one metal or graphite; according to the present invention, it has an alloy that includes at least copper and tin. Preferably, the electrode bearer has at least one crystal lattice; in practice, it has a large number of crystal lattices. The electrode bearer conducts electrons from this active electrode material via the supply line to the consumer, and also in the opposite direction.

In addition, the above-named electrode has active electrode material. The active electrode material is a material mixture that has for example a pastelike character. This active electrode material stands in effective connection with the electrolytes. An exchange of ions also takes place between these two. The active electrode material is applied onto the electrode bearer on one side or on both sides, and stands in electrical effective connection therewith. Electrons are transferred by conduction between the electrode bearer and the active electrode material.

Preferably, the electrode bearer is formed from an electrically conductive alloy that predominantly contains copper, as well as tin with a content of at least approximately 0.01 weight %. The solidified alloy has a large number of crystal lattices. During the solidification of liquid copper, the individual copper atoms form a preferred crystal lattice shape. Tin atoms that are present replace individual copper atoms in this crystal lattice. A certain volume of the material thus predominantly has copper atoms, along with a certain number of tin atoms as what are called foreign atoms.

In the supplying of an electrical drive of a motor vehicle, a total discharging cannot always be reliably excluded. Even given certain residual charges or residual voltages, copper already becomes detached from an electrode bearer. This detachment process is not fully reversible, so that the electrode bearer or the energy storage device ages. The formation of an electrode bearer from this alloy has the consequence that, in comparison to other copper alloys having a low residual charge or residual voltage, less copper is irreversibly detached. With the use of the proposed alloy for the electrode bearer, the underlying object of the present invention is achieved.

The electrode fashioned as described above is therefore suitable in particular for large-format energy storage devices having a large capacity and a high efficiency, as are required for example for electric vehicles and for electric hybrid vehicles.

Preferably, the alloy for this electrode bearer is manufactured in such a way that the copper contained forms the greatest portion by weight of this alloy.

The alloy preferably has mixed crystals of copper and tin. In these mixed crystals, a certain number of copper atoms are replaced by tin atoms. In comparison to a copper atom, a tin atom has a slightly larger atomic radius. The larger diameter of the tin atoms, or foreign atoms, causes a distortion of the lattice of copper atoms. In this way, a mechanical fastening of the material or of the electrode bearer is also achieved. In addition, this alloy is distinguished by high electrical and thermal conductivities. This alloy also has good resistance to corrosion and good resistance to stress crack corrosion.

The tin content of the electrode bearer or of the alloy is preferably in a range from 0.05 to 0.3 weight %, particularly preferably in a range from 0.1 to approximately 0.15 weight %.

According to a second aspect, the above-named object is solved by an energy storage device having the features of claim 7. Advantageous constructions and developments of the present invention are the subject matter of dependent claims 8 through 14.

The energy storage device contains a first electrode (e.g. negative electrode, anode), a second electrode (e.g. positive electrode, cathode), and a separating element between the first and the second electrode that prevents direct electrical contact between the two electrodes. The first and/or the second electrode are fashioned as an electrode as described above.

The energy storage device can for example be a secondary cell (i.e. a rechargeable galvanic cell), a primary cell (i.e. a non-rechargeable galvanic cell), a capacitor, or the like.

The use of the electrode according to the present invention in a lithium (ion) cell is particularly preferred. Here, the energy storage device has at least two electrodes, a separating means that does not conduct electrons, and in addition an electrolyte as an ion conductor. Here, the electrolyte is situated at least partly in the separating means. Preferably, at least one of the electrodes and/or this electrolyte has lithium and/or lithium ions.

In a further construction of the present invention, the energy storage device can contain a stack of a plurality of first electrodes and a plurality of second electrodes that are stacked one over the other in alternating fashion, and between which a separating element is respectively situated. The present invention is advantageously capable of being used both in energy storage devices in which the first and the second electrode or electrodes are coated and in those in which the first and the second electrode or electrodes are wound.

For better understanding, the above, as well as additional, features and advantages of the present invention are described in more detail in the following description of preferred, non-limiting exemplary embodiments, with reference to the accompanying drawings.

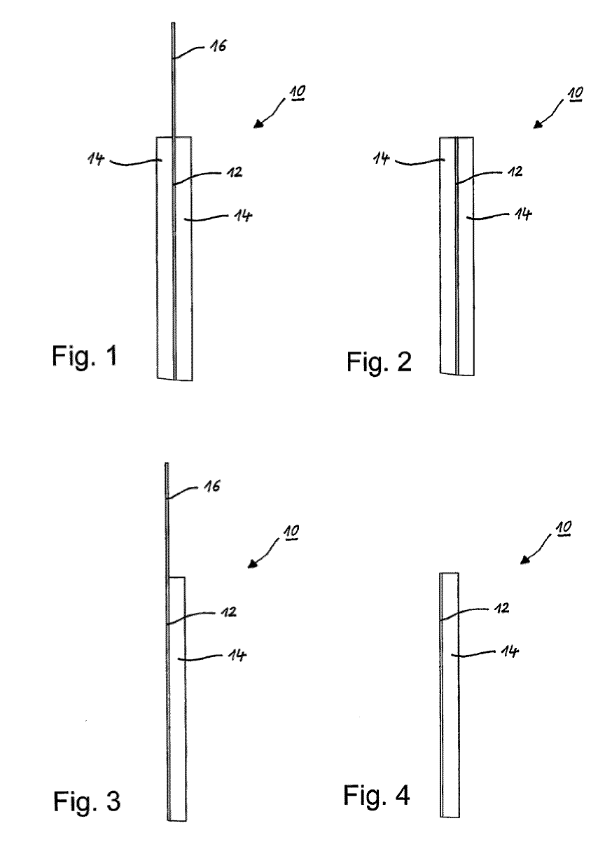

FIG. 1 shows a schematic sectional view of an electrode according to a first exemplary embodiment of the present invention;

FIG. 2 shows a schematic sectional view of an electrode according to a second exemplary embodiment of the present invention;

FIG. 3 shows a schematic sectional view of an electrode according to a third exemplary embodiment of the present invention;

FIG. 4 shows a schematic sectional view of an electrode according to a fourth exemplary embodiment of the present invention;

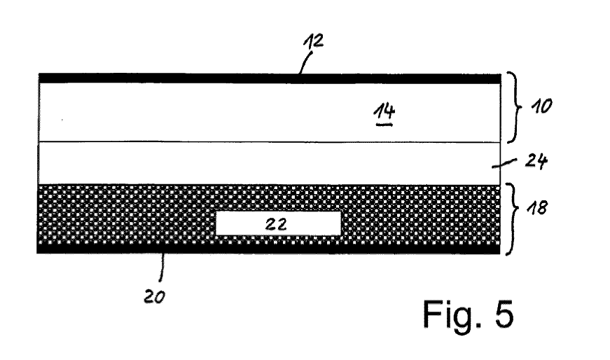

FIG. 5 shows a schematic sectional view of an energy storage device having an electrode according to the present invention.

With reference to FIGS. 1 through 4, first the construction of various exemplary embodiments of an electrode for an energy storage device is explained in more detail.

FIG. 1 shows a first exemplary embodiment of an electrode configured according to the present invention for an energy storage device, in a sectional view. Electrode 10 has an electrode bearer 12 onto which an active electrode material 14 has been applied on both sides. In the exemplary embodiment of FIG. 1, the active electrode material 14 is not applied over the entire area of electrode bearer 12, so that electrode bearer 12 protrudes from active electrode material 14 on at least one side. This part of electrode bearer 12 protruding from active electrode material 14 can thus be used as a current conductor 16 for supplying a charge current to electrode 10, or for carrying away a discharge current from electrode 10.

The exemplary embodiment illustrated in FIG. 2 is distinguished from the above first exemplary embodiment in that the active electrode material 14 is applied on both sides over the entire surface of electrode bearer 12, so that electrode bearer 12 does not protrude from active electrode material 14. In this case, if warranted, during the construction of an energy storage device a separate current conductor can be connected (e.g. welded) to electrode bearer 12 in prolongation thereof.

The third exemplary embodiment of the electrode shown in FIG. 3 is distinguished from the above-described first exemplary embodiment in that electrode bearer 12 is coated with active electrode material 14 on only one side.

The fourth exemplary embodiment of FIG. 4 presents a combination of the above second and third exemplary embodiments. That is, active electrode material 14 is applied on only one side of electrode bearer 12, and electrode bearer 12 is provided with active electrode material 14 on the one side essentially over its entire surface.

In all the specific embodiments, electrode bearer 12 is provided for example in the form of a foil, of a strip, a plate, a disk, or the like, and is for example electrolytically deposited on rollers from a corresponding solution. The thickness of electrode bearer 12 is for example in the range of approximately 4 μm to approximately 80 μm, more preferably in the range from approximately 5 μm to approximately 50 μm, and still more preferably in the range from approximately 5 μm to approximately 30 μm.

FIG. 5 shows an example of an energy storage device in which an electrode 10 as described above is used.

The energy storage device, for example a rechargeable secondary cell, a primary cell, a capacitor, or the like, has a first electrode 10 (e.g. a negative electrode or anode), a second electrode 18 (e.g. a positive electrode or cathode), and a separating element 24 between the two electrodes 10, 18. As first electrode 10, for example an electrode is used as shown in FIGS. 1 through 4. Second electrode 18 is constructed fundamentally analogously to first electrode 10, i.e., it also contains an electrode bearer 20 and an active electrode material 22 that is applied onto electrode bearer 20 on one side or on both sides.

Separating element 24 between the two electrodes 10, 18 prevents a direct electrically conductive contact between the two electrodes 10, 18. Separating element 24 can terminate flush with electrodes 10, 18 (in particular their active areas 14, 22), as is indicated in FIG. 5. However, it can also be advantageous if separating element 24 protrudes, on at least one side, past active electrode material 14, 22 of directly adjacent electrode 10, 18.

The energy storage device can for example comprise exactly one first electrode 10, a separating element 24, and a second electrode 18, as is shown in FIG. 5. However, in many cases of application it is advantageous if the energy storage device contains a stack of a plurality of first electrodes 10 and a plurality of second electrodes 18, stacked one over the other in alternating fashion with a separating element 24 situated between each of them.

Moreover, the energy storage device can have the design explained on the basis of FIG. 5, or the stacked construction, either in a wound form or in a coated form.

According to the present invention, it is proposed to use a specific material for the first and/or for the second electrode 10, 18 of the energy storage device. The material selection explained in the following is particularly advantageously usable for an anode 10 of a lithium-ion cell, without intending to limit the present invention to this specific application.

Electrode bearer 12 of electrode 10 (see FIGS. 1 through 4) for an energy storage device (see FIG. 5) is made of an alloy that contains at least predominantly copper, as well as tin with a content of at least approximately 0.01 weight %.

Preferably, the alloy has mixed crystals of copper and 10. Here, the crystal lattice is predominantly formed by copper. Individual copper atoms are replaced by tin atoms, which occupy their lattice locations.

The tin content of the electrode bearer is preferably in a range from 0.05 to 0.3 weight %, particularly preferably in a range from 0.1 to approximately 0.15 weight %.

As a specific example for the material of electrode bearer 10 of an electrode 10 for an energy storage device, the copper material can be used having the designation “PNA 216” of Prymetall GmbH & Co. KG, Germany. This copper material has a tin content of at least 0.10 weight %. The specific electrical conductivity of this copper material is approximately 49 MS/m (in the soft state), and its heat conductivity is approximately 350 W/m-K.

Within the context of the present invention, there are no particular limitations with regard to the materials for active electrode material 14 of anode 10, for electrode bearer 20, and for active electrode material 22 of cathode 18, as well as for separating element 24. Suitable materials for these components that can be used in the case of a lithium-ion cell are for example extensively described in the above-named DE 10 2005 042 916 A1, to which reference is here expressly made. Moreover, the manufacture of electrodes 10, 18 and of the energy storage device is not limited to specific methods in the context of the present invention.

The above-described electrode of the present invention is in particular for large-format energy storage devices (specifically secondary lithium-ion cells) having a large capacity and a large power capacity of more than 3 or 5 Ah up to 300 Ah and more, which additionally require outstanding long-term stability of for example more than 3000 charge/discharge cycles and more, as well as supply safety. Energy storage devices having such an electrode can advantageously be used for example in electric vehicles and in electric hybrid vehicles.

1. An electrode for an energy storage device, comprising: an electrode bearer and an active electrode material that is applied onto the electrode bearer on one side or on both sides, the electrode bearer being made of an alloy having a copper portion, said alloy additionally containing at least tin with a content of at least approximately 0.01 weight %.

2. The electrode as recited in claim 1, characterized in that the copper portion forms the greatest portion by weight of the alloy.

3. The electrode as recited in claim 1, characterized in that the alloy has mixed crystals that contain copper and tin.

4. The electrode as recited in claim 1, characterized in that the alloy of the electrode bearer contains at least approximately 0.05 weight % tin.

5. The electrode as recited in claim 1, characterized in that the alloy of the electrode bearer contains at least approximately 0.1 weight % tin.

6. The electrode as recited in one of claim 1, characterized in that the alloy of the electrode bearer contains at most approximately 0.3 weight % tin.

7. The electrode as recited in claim 1, characterized in that the alloy of the electrode bearer contains at most approximately 0.15 weight % tin.

8. An energy storage device, comprising: a first electrode; a second electrodes; and a separating elements between the first and the second electrode, at least one of the first and the second electrode is being fashioned as an electrode as recited in claim 1.

9. The energy storage device as recited in claim 8, characterized in that the energy storage device is a secondary cell.

10. The energy storage device as recited in claim 8, characterized in that the energy storage device is a primary cell.

11. The energy storage device as recited in claim 8, characterized in that the energy storage device is a capacitor.

12. The energy storage device as recited in claim 9, characterized in that the energy storage device additionally contains an electrolyte, and at least an electrode and said electrolyte comprises at least one of lithium and lithium ions.

13. The energy storage device as recited in claim 8, characterized in that the energy storage device contains a stack of a plurality of first electrodes and a plurality of second electrodes that are stacked one over the other in alternating fashion and between which there is respectively situated a separating element.

14. The energy storage device as recited in claim 8, characterized in that the first and the second electrode or electrodes are coated.

15. The energy storage device as recited in claim 8, characterized in that the first and the second electrode or electrodes are wound.
